(19) United States
(12) Patent Application Publication
(10) Pub. No.: US 2026/0314882 A1
(43) Pub. Date: Oct. 15, 2026

(54) ELECTRIC OPENING/CLOSING DEVICE FOR TOILET DEVICE

(71) Applicants: MINEBEA MITSUMI Inc., Kitasaku-gun (JP); TOTO LTD., Fukuoka (JP)

(72) Inventors: Shinnosuke KAKURA, Kitasaku-gun (JP); Masamori OIWA, Kitasaku-gun (JP); Mana AMANO, Fukuoka (JP); Yosuke KONOMI, Fukuoka (JP); Koyo IKEDA, Fukuoka (JP); Tomohiro NOGUCHI, Fukuoka (JP)

(21) Appl. No.: 19/466,936

(22) Filed: Feb. 2, 2026

(30) Foreign Application Priority Data
Feb. 5, 2025 (JP) 2025-017604

(51) Int. Cl. A47K 13/10

(52) U.S. Cl. CPC A47K 13/10

(57) ABSTRACT

An electric opening/closing device for a toilet device according to an embodiment includes three or more gears and an output shaft. The three or more gears are disposed in a case and the torque of a motor outside the case is transmitted thereto as an input. The output shaft rotates according to rotation of the three or more gears to rotate at least one of a toilet seat and a toilet lid. Out of the three or more gears, with respect to one gear having a smallest number of teeth, another gear having a narrow tooth width is provided on an output shaft side. That one gear and the other gear are not directly meshed with each other. A magnetic sensor that detects rotation of the output shaft is disposed in a gap formed in the case due to a difference in tooth width between the three or more gears.

### CROSS-REFERENCE TO RELATED APPLICATIONS

The present application claims priority to and incorporates by reference the entire contents of Japanese Patent Application No. 2025-017604 filed in Japan on Feb. 5, 2025.

### BACKGROUND OF THE INVENTION

### 1. Field of the Invention

The present invention relates to an electric opening/closing device for a toilet device.

### 2. Description of the Related Art

Conventionally, there has been provided an electric opening/closing device for a toilet device that opens and closes a toilet device such as a toilet seat or a toilet lid by means of a drive force of a motor (for example, Japanese Patent No. 6375419).

However, in the electric opening/closing device described in Japanese Patent No. 6375419, the driven gear for rotation detection is used to transmit the rotation of the gear to the rotation detector in order to detect the rotational position of the output member, and thus, a gear for detecting the rotation (angle) is required, which increases the size of the device due to the configuration for angle detection. It is therefore desired to prevent an increase in size of the device while enabling angle detection on the output side.

### SUMMARY OF THE INVENTION

It is an object of the present invention to at least partially solve the problems in the conventional technology.

According to one aspect of an embodiment, an electric opening/closing device for a toilet device that electrically opens/closes a toilet seat or a toilet lid by driving a motor, the electric opening/closing device for a toilet device includes three or more gears disposed in a case and to which torque of the motor outside the case is transmitted as an input; and an output shaft that rotates according to rotation of the three or more gears to rotate at least one of the toilet seat and the toilet lid; wherein out of the three or more gears, with respect to one gear having a smallest number of teeth, another gear having a narrow tooth width is provided on an output shaft side, the one gear and the other gear are not directly meshed with each other, and a magnetic sensor configured to detect rotation of the output shaft is disposed in a gap formed in the case due to a difference in tooth width between the three or more gears.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating an example of a toilet bowl equipped with an electric toilet seat in which an electric opening/closing device according to an embodiment is disposed;

FIG. 2 is a perspective view illustrating an example of the electric opening/closing device according to the embodiment;

FIG. 3 is a front view illustrating an example of the electric opening/closing device according to the embodiment;

FIG. 4 is a rear view illustrating an example of the electric opening/closing device according to the embodiment;

FIG. 5 is a side view illustrating an example of the electric opening/closing device according to the embodiment;

FIG. 6 is a side cross-sectional view illustrating an example of the electric opening/closing device according to the embodiment;

FIG. 7 is a cross-sectional view of a main part illustrating an example of the electric opening/closing device according to the embodiment;

FIG. 8 is a rear view illustrating an example of a configuration within a case of the electric opening/closing device;

FIG. 9 is a perspective view illustrating an example of a configuration of a cover of the electric opening/closing device;

FIG. 10 is a perspective view illustrating an example of a configuration of a cover of the electric opening/closing device;

FIG. 11 is a rear view illustrating an example of a configuration within a case of the electric opening/closing device;

FIG. 12 is a perspective view illustrating an example of a block of the electric opening/closing device; and

FIG. 13 is a perspective view illustrating an example of a block of the electric opening/closing device.

### DETAILED DESCRIPTION OF THE PREFERRED EMBODIMENTS

Hereinafter, an electric opening/closing device according to an embodiment will be described with reference to the drawings. It should be noted that the drawings are schematic, and the dimensional relationships of the elements, the ratios of the elements, and the like may differ from those in practice. The drawings may include parts having different dimensional relationships and ratios.

### Embodiment

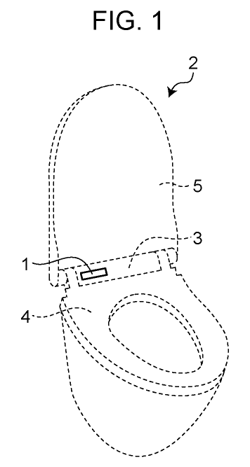

As illustrated in FIG. 1, an electric opening/closing device 1 according to an embodiment is disposed in a casing 3 of a toilet bowl 2 equipped with an electric toilet seat, and drives to open and close a toilet seat 4 and a toilet lid 5. FIG. 1 is a perspective view illustrating an example of a toilet bowl equipped with an electric toilet seat in which an electric opening/closing device according to the embodiment is disposed. For example, in FIG. 1, the casing 3 in which the electric opening/closing device 1 is disposed, the toilet seat 4, and the toilet lid 5 constitute a toilet device. Hereinafter, the electric opening/closing device for opening/closing the toilet seat 4 will be described as an example, but the toilet lid 5 can be opened and closed in the same manner.

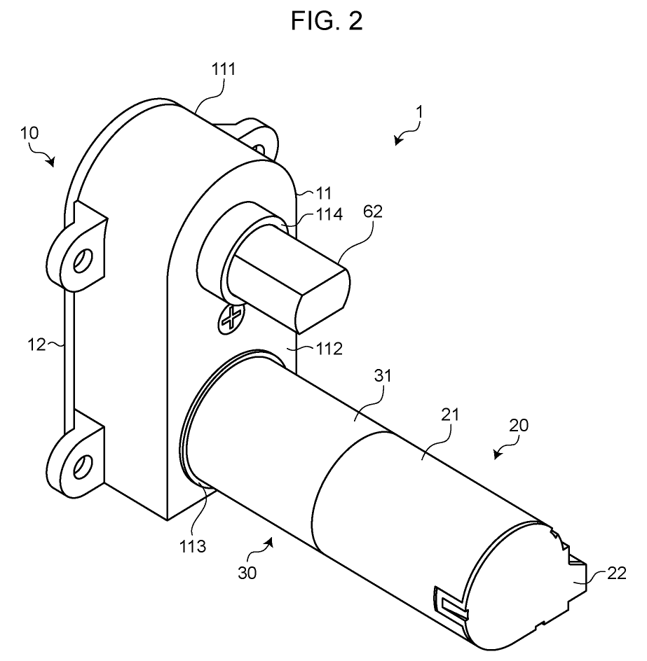

As illustrated in FIG. 2, the electric opening/closing device 1 includes a gear housing part 10, a motor unit 20, and a planetary gear part 30. FIG. 2 is a perspective view illustrating an example of the electric opening/closing device according to the embodiment. The electric opening/closing device 1 is an electric opening/closing device for a toilet device that electrically opens/closes the toilet seat 4 or the toilet lid 5 by a drive force of a motor 23 described later.

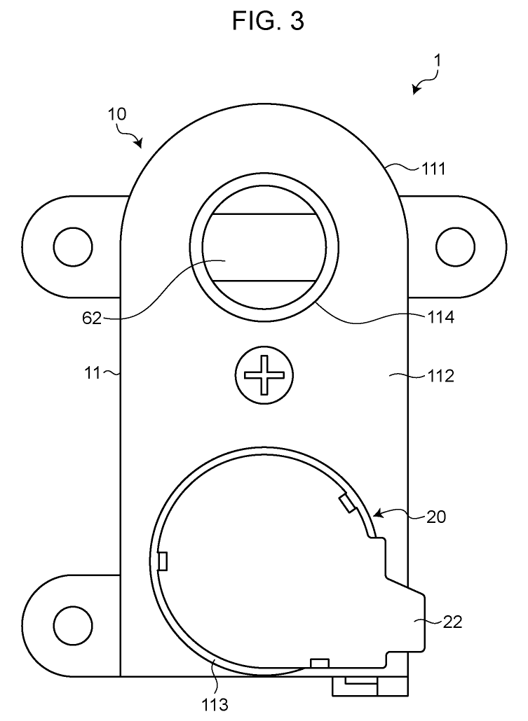

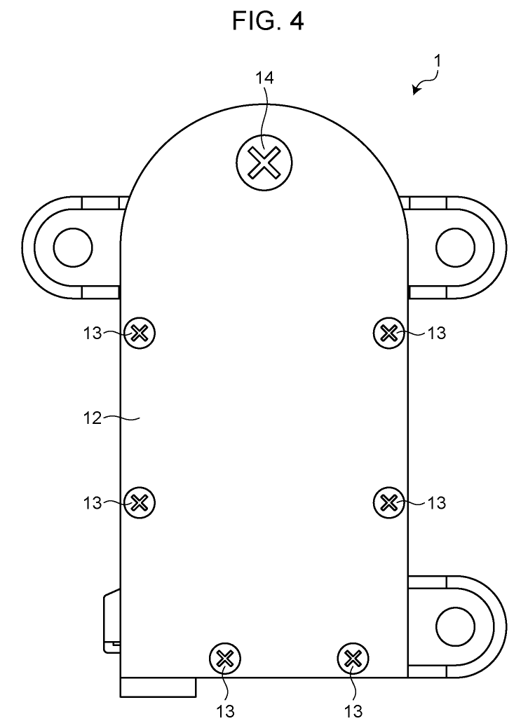

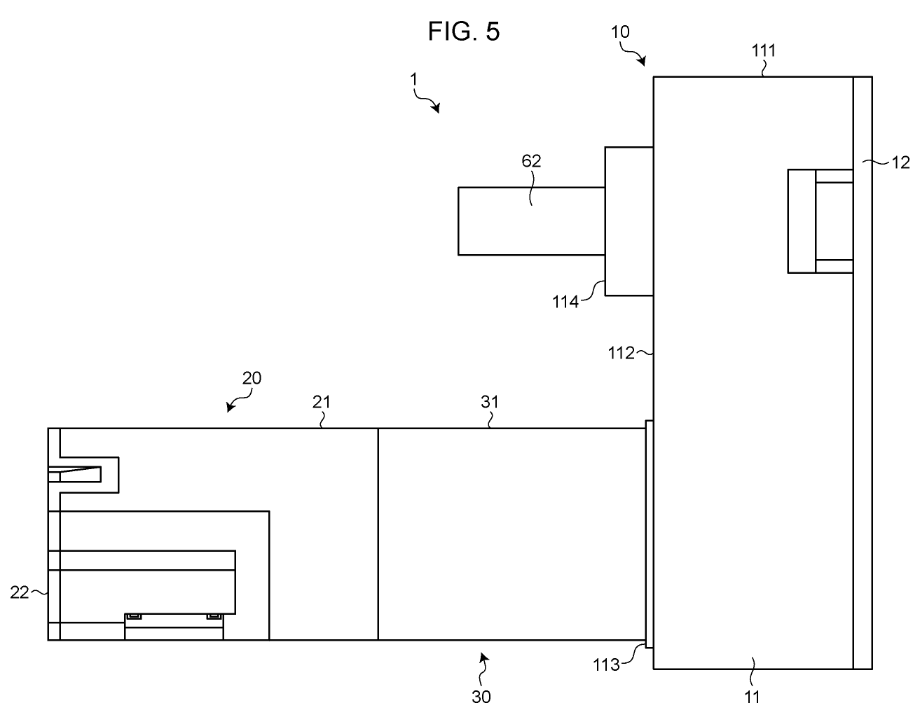

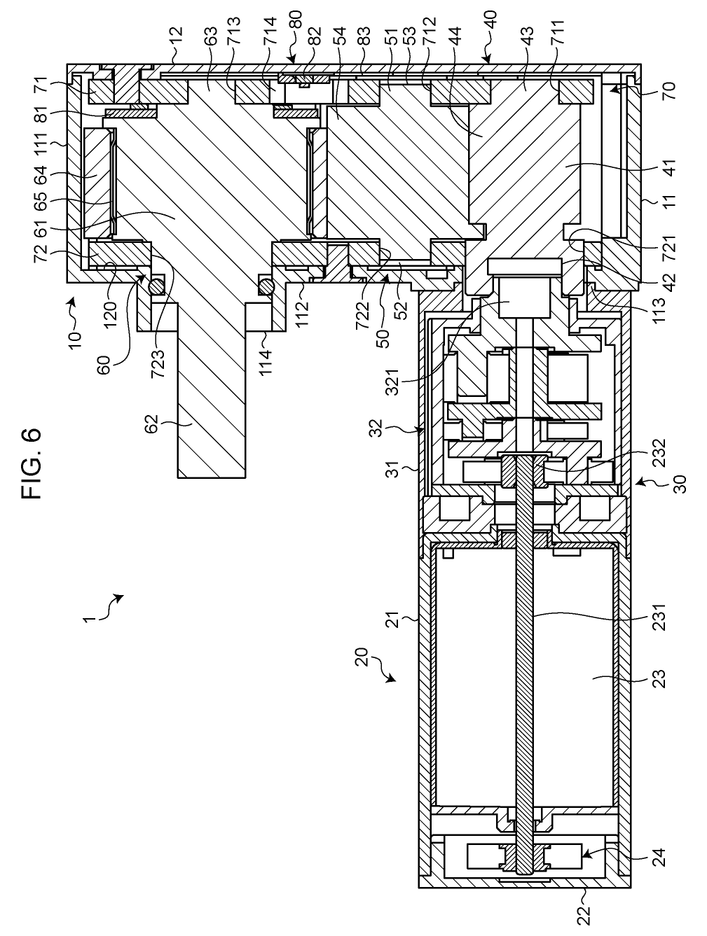

Hereinafter, an outline of a configuration of the electric opening/closing device 1 will be described with reference to FIGS. 2 to 6. FIG. 3 is a front view illustrating an example of the electric opening/closing device according to the embodiment. FIG. 4 is a rear view illustrating an example of the electric opening/closing device according to the embodiment. FIG. 5 is a side view illustrating an example of the electric opening/closing device according to the embodiment. FIG. 6 is a side cross-sectional view illustrating an example of the electric opening/closing device according to the embodiment.

In the gear housing part 10, an internal space is formed by a first case 11 that is a casing whose one surface is open and a cover 12 that closes the one surface, and an input gear part 40, an intermediate gear part 50, and an output gear part 60 are disposed in the internal space.

The motor unit 20 functions as a drive source and a power source for pivoting the toilet seat 4 and the toilet lid 5 to which the electric opening/closing device 1 is attached. The motor unit 20 includes a second case 21, a lid part 22, a motor 23, and a motor angle detector 24. The motor 23 is disposed in the second case 21. Openings are formed at both ends of the second case 21, and an output rotary shaft 231 of the motor unit 20 protrudes from one end side. The motor angle detector 24 is disposed on the other end side of the second case 21, and the lid part 22 is disposed and closed on the other end of the second case 21.

The motor unit 20 has a connector used for power supply and communication of information from the motor angle detector 24. The motor unit 20 is supplied with a drive signal via a lead wire or the like connected to the connector. Further, the supply of the drive signal rotates the output rotary shaft 231 of the motor 23 in the motor unit 20. Note that the motor 23 of the motor unit 20 is not particularly limited, and may be a DC motor, a DC brushless motor, a stepping motor, or the like.

A motor gear 232 is disposed at an end of the output rotary shaft 231 of the motor unit 20. The motor gear 232 of the motor unit 20 rotates together with the output rotary shaft 231. The motor gear 232 of the motor unit 20 meshes with a planetary gear mechanism 32 in a third case 31 of the planetary gear part 30.

The planetary gear part 30 is disposed between the motor unit 20 and the gear housing part 10 to transmit the rotation of the motor unit 20 to the gear part (input gear part 40) in the gear housing part 10. The planetary gear part 30 includes the third case 31 and the planetary gear mechanism 32. The planetary gear mechanism 32 is disposed in the third case 31.

Openings are formed at both ends of the third case 31, and the output rotary shaft 231 of the motor unit 20 is inserted from one end side. The configuration of the planetary gear mechanism 32 is similar to that of a conventional planetary gear mechanism. The shape and the like of the gear are not illustrated, but the planetary gear mechanism 32 has a planetary gear, an internal gear, and the like, is connected to the motor gear 232 of the motor unit 20 as a sun gear, and rotates according to the rotation of the output rotary shaft 231. For example, the planetary gear mechanism 32 has three stages of planetary gears, and the planetary gear of the first stage meshes with the motor gear 232 of the motor unit 20.

A planetary carrier 321 of the planetary gear mechanism 32 is disposed on the other end side of the third case 31. For example, the planetary carrier 321 disposed on the other end side of the third case 31 meshes with one end 42 of the input gear part 40. The planetary gear mechanism 32 may be made of, for example, metal, resin, or the like. Any material may be used for the planetary gear mechanism 32 as long as it meets predetermined conditions such as strength.

As described above, the input gear part 40, the intermediate gear part 50, and the output gear part 60 are disposed in the internal space formed by the first case 11 and the cover 12. The first case 11 has a rectangular box-shaped side peripheral surface 111 having one end in the longitudinal direction formed in a U-shape, and a first surface 112 covering one surface in the thickness direction of the side peripheral surface 111. The first case 11 is formed in a rectangular box shape in which a second surface 120 side, which is the rear surface of the first surface 112, is open and one surface in the thickness direction is open. The cover 12 is disposed at a position facing the second surface 120 of the first case 11 so as to cover one open surface (opening) of the first case 11, so that the first case 11 forms the internal space together with the cover 12.

The first case 11 has, on the first surface 112, a first opening 113 for transmitting the torque of the motor 23 to a first gear 44, and a second opening 114 through which an output shaft 62 extends beyond the first case 11. The first case 11 also has a partition wall 115 on which a connector 84, described later, is disposed and four protrusions 116 used for attaching the cover 12. For example, the four protrusions 116 are provided on the partition wall 115 so as to protrude toward the inside of the first case 11 along the side peripheral surface 111.

The input gear part 40 is disposed in the first case 11. The input gear part 40 includes a base 41, one end 42 in the axial direction, another end 43 in the axial direction, and the first gear 44. As described above, in the input gear part 40, the one end 42 is disposed at one end in the axial direction of the base 41, the other end 43 is disposed at the other end in the axial direction of the base 41, and the first gear 44 is disposed along the circumferential direction of the base 41. The first gear 44 is a gear to which the torque of the motor 23 outside the first case 11 is transmitted as an input. The first gear 44 is one gear having the smallest number of teeth among the first gear 44, a second gear 54, and a third gear 64. Although the first gear 44 is illustrated in a cylindrical shape in the drawings and a detailed illustration of the shape of the gear is omitted, the first gear 44 has a shape in which the teeth are arranged along the circumferential direction of the base 41 and has a tooth width of a predetermined length along the axial direction of the base 41.

The intermediate gear part 50 is an idle gear disposed in the first case 11. Note that a plurality of idle gears (intermediate gear part 50 and the like) may be provided. The intermediate gear part 50 includes a base 51, one end 52 in the axial direction, another end 53 in the axial direction, and the second gear 54. As described above, in the intermediate gear part 50, the one end 52 is disposed at one end in the axial direction of the base 51, the other end 53 is disposed at the other end in the axial direction of the base 51, and the second gear 54 is disposed along the circumferential direction of the base 51. The second gear 54 is a gear that meshes with the first gear 44. As a result, the rotation of the input gear part 40 is transmitted to the intermediate gear part 50. Although the second gear 54 is illustrated in a cylindrical shape in the drawings and a detailed illustration of the shape of the gear is omitted, the second gear 54 has a shape in which the teeth are arranged along the circumferential direction of the base 51 and has a tooth width of a predetermined length along the axial direction of the base 51.

The output gear part 60 is disposed in the first case 11. The output gear part 60 is a gear part that is disposed in the first case 11 and rotates the output shaft 62 by the torque of the motor 23 outside the first case 11. The output gear part 60 includes a base 61, the output shaft 62 provided at one end in the axial direction, another end 63 in the axial direction, and the third gear 64. As described above, in the output gear part 60, the output shaft 62 is disposed at one end in the axial direction of the base 61, the other end 63 is disposed at the other end in the axial direction of the base 61, and the third gear 64 is disposed along the circumferential direction of the base 61.

The output shaft 62 is connected to at least one of the toilet seat 4 and the toilet lid 5. The output shaft 62 rotates at least one of the toilet seat 4 and the toilet lid 5. The third gear 64 is a gear that meshes with the second gear 54. As a result, the rotation of the intermediate gear part 50 is transmitted to the output gear part 60. Although the third gear 64 is illustrated in a cylindrical shape in the drawings and a detailed illustration of the shape of the gear is omitted, the third gear 64 has a shape in which the teeth are arranged along the circumferential direction of the base 61 and has a tooth width of a predetermined length along the axial direction of the base 61. The third gear 64 is another gear having a narrower tooth width than the first gear 44. As illustrated in FIG. 6, the third gear 64 and the first gear 44 are not directly meshed with each other. The diameter of the third gear 64 is larger than the diameter of the second gear 54. The diameter of the third gear 64 is the largest among the first gear 44, the second gear 54, and the third gear 64.

The output gear part 60 includes an output shaft part having the output shaft 62 and the third gear 64 configured separately from the output shaft part, and forms a torque limiter mechanism between the output shaft part and the third gear 64. For example, the output shaft part of the output gear part 60 includes the base 61, the output shaft 62, and the other end 63. As described above, the output shaft 62 and the third gear 64 are configured separately, and the torque limiter mechanism is provided between the output shaft 62 and the third gear 64.

The gears (first gear 44, second gear 54, third gear 64, and the like) of the gear parts such as the input gear part 40, the intermediate gear part 50, and the output gear part 60 constitute a speed reduction mechanism in which the output is decelerated relative to the input of the motor 23. The gears (first gear 44, second gear 54, third gear 64, and the like) of the gear parts such as the input gear part 40, the intermediate gear part 50, and the output gear part 60 may be any type of gears such as a spur gear or a helical gear as long as it is an applicable gear.

As illustrated in FIG. 6, the output gear part 60 forms the torque limiter mechanism by disposing a tolerance ring 65 between the output shaft part and the third gear 64. For example, in a case where the tolerance ring 65 is fixed to the third gear 64, when a force larger than a predetermined value is applied to the output shaft 62 and the output shaft 62 rotates, the output shaft 62 slides with respect to the tolerance ring 65, so that the rotation is not transmitted to the third gear 64 and the function of the torque limiter mechanism is achieved. Similarly, when the motor 23 rotates with a force larger than a predetermined value, the rotation is not transmitted between the tolerance ring 65 and the output shaft 62, so that the function of the torque limiter mechanism is achieved. The tolerance ring 65 may be fixed to the output shaft 62 side. The torque limiter mechanism is not limited to the tolerance ring 65, and any type can be adopted as long as it functions as a torque limiter. For example, the load direction of the torque limiter may be either radial or thrust. For example, the transmission method of the torque limiter is not limited to friction, and may be any transmission method such as a spring or magnetism. For example, the type of the torque limiter may be a magnet coupling or the like.

In the first case 11, a pair of reinforcing plates 71 and 72 is disposed at positions sandwiching the input gear part 40, the intermediate gear part 50, and the output gear part 60. The reinforcing plate 71 is disposed in the first case 11. The reinforcing plate 71 is disposed at a position so as to sandwich the first gear 44, the second gear 54, and the output gear part 60 together with the reinforcing plate 72. The reinforcing plate 71 includes a first support part 711, a second support part 712, and a third support part 713 that support the shaft of the gear part.

As illustrated in FIG. 6, the first support part 711 of the reinforcing plate 71 is a hole into which the other end 43 of the input gear part 40 is inserted. The first support part 711 of the reinforcing plate 71 supports the other end 43 of the input gear part 40 by receiving the other end 43 of the input gear part 40 inserted into the first support part 711. In the example of FIG. 6, the case where the first support part 711 of the reinforcing plate 71 is a hole is illustrated, but the first support part 711 may have any configuration such as a projection as long as the first support part 711 can support the other end 43 of the input gear part 40.

Further, the second support part 712 of the reinforcing plate 71 is a hole into which the other end 53 of the intermediate gear part 50 is inserted. The second support part 712 of the reinforcing plate 71 supports the other end 53 of the intermediate gear part 50 by receiving the other end 53 of the intermediate gear part 50 inserted into the second support part 712. In the example of FIG. 6, the case where the second support part 712 of the reinforcing plate 71 is a hole is illustrated, but the second support part 712 may have any configuration such as a projection as long as the second support part 712 can support the other end 53 of the intermediate gear part 50.

Further, the third support part 713 of the reinforcing plate 71 is a hole into which the other end 63 of the output gear part 60 is inserted. The third support part 713 of the reinforcing plate 71 supports the other end 63 of the output gear part 60 by receiving the other end 63 of the output gear part 60 inserted into the third support part 713. In the example of FIG. 6, the case where the third support part 713 of the reinforcing plate 71 is a hole is illustrated, but the third support part 713 may have any configuration such as a projection as long as the third support part 713 can support the other end 63 of the output gear part 60.

As illustrated in FIG. 6, a first support part 721 of the reinforcing plate 72 is a hole into which the one end 42 of the input gear part 40 is inserted. The first support part 721 of the reinforcing plate 72 supports the one end 42 of the input gear part 40 by receiving the one end 42 of the input gear part 40 inserted into the first support part 721. The first support part 721 of the reinforcing plate 72 is disposed at a position overlapping with the first opening 113 of the first case 11, and the input gear part 40 is connected to the planetary gear part 30 via a portion communicating with the outside formed by the first support part 721 and the first opening 113.

Further, a second support part 722 of the reinforcing plate 72 is a hole into which the one end 52 of the intermediate gear part 50 is inserted. The second support part 722 of the reinforcing plate 72 supports the one end 52 of the intermediate gear part 50 by receiving the one end 52 of the intermediate gear part 50 inserted into the second support part 722. In the example of FIG. 6, the case where the second support part 722 of the reinforcing plate 72 is a hole is illustrated, but the second support part 722 may have any configuration such as a projection as long as the second support part 722 can support the one end 52 of the intermediate gear part 50.

Further, a third support part 723 of the reinforcing plate 72 is a hole into which the output shaft part of the output gear part 60 is inserted. The third support part 723 of the reinforcing plate 72 supports the output shaft part of the output gear part 60 by receiving the output shaft part of the output gear part 60 inserted into the third support part 723. The third support part 723 of the reinforcing plate 72 is disposed at a position overlapping with the second opening 114 of the first case 11, and the output shaft part of the output gear part 60 passes through the third support part 723 and the second opening 114, and the output shaft 62 extends beyond the first case 11.

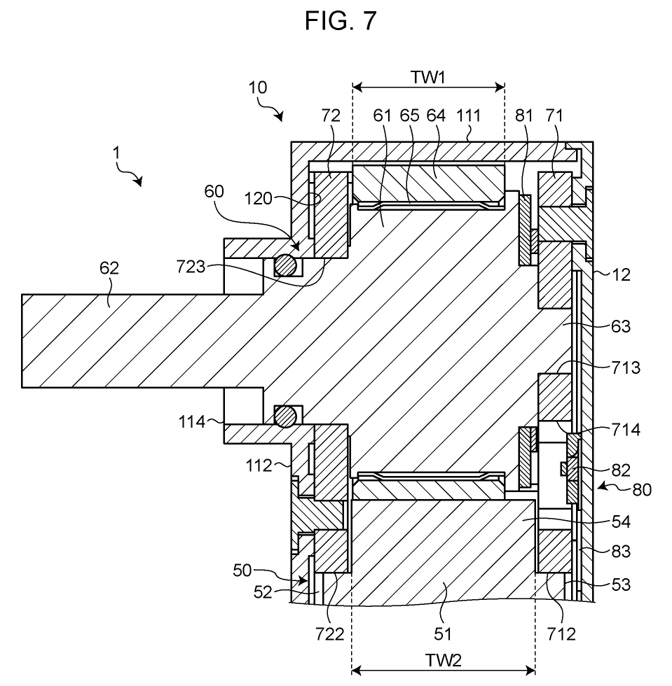

As illustrated in FIG. 7, a tooth width TW1 of the third gear 64 is narrower (smaller) than a tooth width TW2 of the second gear 54. FIG. 7 is a cross-sectional view of a main part illustrating an example of the electric opening/closing device according to the embodiment. As a result, as illustrated in FIGS. 6 and 7, a gap is formed at a position in the first case 11 where the output gear part 60 is disposed. In the gap formed at the position in the first case 11 where the output gear part 60 is disposed, components of an output shaft angle detector 80, which is an angle detector that detects the rotation of the output gear part 60, are disposed.

The output shaft angle detector 80 includes a magnet 81 and a Hall IC 82. The Hall IC 82 is an integrated circuit (IC) in which a Hall element and an operational amplifier are integrated. For example, the Hall IC 82 is a magnetic sensor constituting the output shaft angle detector 80 together with the magnet 81. The Hall IC 82 is disposed in a gap generated in the first case 11 due to a difference in tooth width between the first gear 44, the second gear 54, and the third gear 64.

The magnet 81 is formed in a hollow disk shape, and the shape of the inner periphery (hollow portion) is formed in accordance with the shape of the other end 63 of the output gear part 60. For example, the inner peripheral shape of the magnet 81 is formed in a D-cut shape in accordance with the shape of the other end 63 of the output gear part 60. Thus, the magnet 81 is fitted to the other end 63 of the output gear part 60, and rotates together with the output gear part 60. Note that the magnet 81 can have any configuration as long as the angle can be detected together with the Hall IC 82, and may be any magnet such as a bipolar magnet or a multipolar magnet.

As illustrated in FIGS. 6 and 7, in the internal space formed by the first case 11 and the cover 12, the magnet 81 that rotates together with the output shaft 62 is disposed in the gap formed on the cover 12 side of the location where the output gear part 60 is disposed. The magnet 81 is disposed on one surface side of the reinforcing plate 71, and rotates together with the output gear part 60.

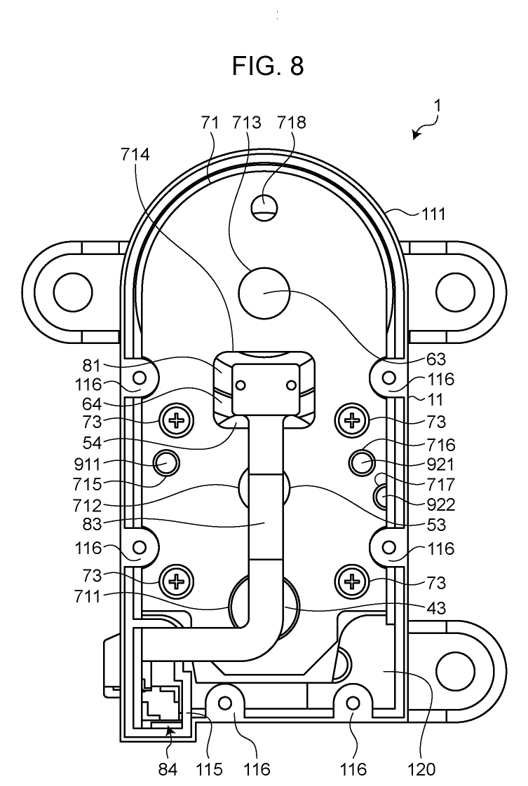

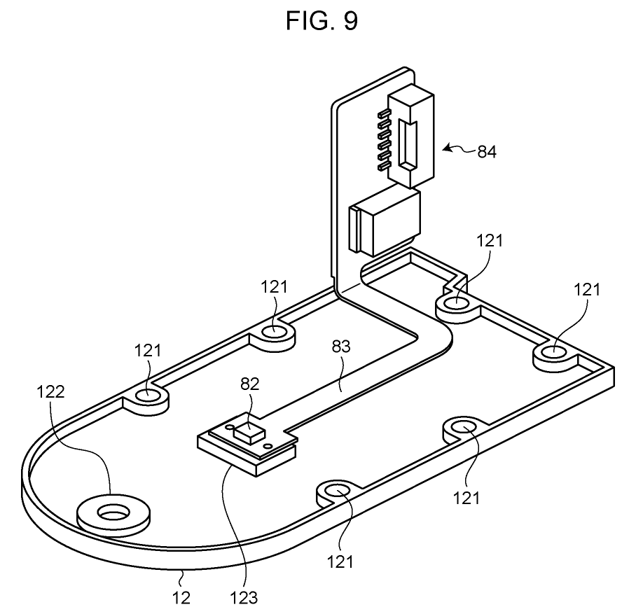

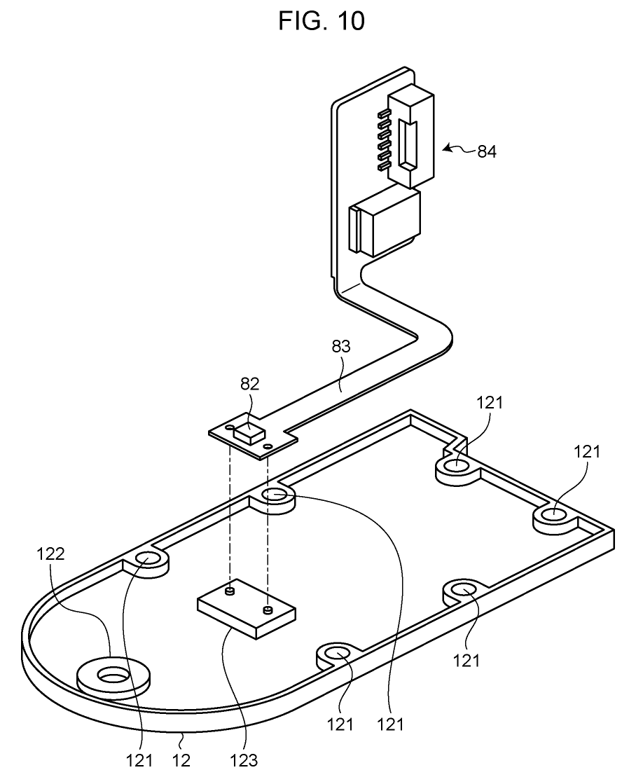

Here, a configuration of the gear housing part 10 on the cover 12 side will be described with reference to FIGS. 8 to 10. FIG. 8 is a rear view illustrating an example of a configuration within a case of the electric opening/closing device. Specifically, FIG. 8 is a rear view of the electric opening/closing device 1 excluding the cover 12 of the gear housing part 10. FIGS. 9 and 10 are perspective views illustrating an example of a configuration of a cover of the electric opening/closing device. Specifically, FIG. 9 is a perspective view illustrating the cover 12 in a state where a substrate part 83 is attached. Specifically, FIG. 10 is a perspective view illustrating how the substrate part 83 is attached to the cover 12.

As illustrated in FIG. 8, the reinforcing plate 71 has a sensing hole 714 that is a hole penetrating in the thickness direction at a position not overlapping with the first support part 711, the second support part 712, and the third support part 713. For example, the sensing hole 714 of the reinforcing plate 71 is formed at a central portion in a direction (left-right direction in FIG. 8) intersecting a direction in which the input gear part 40, the intermediate gear part 50, and the output gear part 60 are arranged. The Hall IC 82 is disposed at a position overlapping with the sensing hole 714 on an opposite surface side of one surface of the reinforcing plate 71 facing the output gear part 60, and detects the angle of the output gear part 60. Note that the position where the sensing hole 714 is provided as illustrated in FIG. 8 is merely an example, and the sensing hole 714 may be provided at any position on the reinforcing plate 71 as long as the entire periphery thereof is surrounded by the reinforcing plate 71 in a plan view of the reinforcing plate 71.

The Hall IC 82 is attached to one end of the substrate part 83, and the connector 84 is attached to the other end of the substrate part 83. For example, the substrate part 83 is a flexible printed circuit (FPC). The Hall IC 82 is connected to the connector 84 used for power supply and communication of information from the output shaft angle detector 80 via the substrate part 83.

As illustrated in FIGS. 9 and 10, the cover 12 has six screw holes 121 and one screw hole 122. The six screw holes 121 of the cover 12 are disposed so as to overlap the holes of the six protrusions 116 of the first case 11, and screws 13 illustrated in FIG. 4 are inserted into the screw holes 121 and the holes of the protrusions 116. This allows the cover 12 to be attached to the first case 11.

The one screw hole 122 of the cover 12 is disposed so as to overlap a screw hole 718 of the reinforcing plate 71, and a screw 14 illustrated in FIG. 4 is inserted into the screw hole 121 and the screw hole 718 illustrated in FIG. 8. This allows the reinforcing plate 71 to be attached to the first case 11.

The cover 12 also has an attachment part 123 for attaching the substrate part 83. The one end of the substrate part 83 is attached to the attachment part 123 of the cover 12. As a result, the Hall IC 82 and the connector 84 connected to the Hall IC 82 via the substrate part 83 are attached to the cover 12.

When the cover 12 is disposed on the second surface, the Hall IC 82 and the connector 84 are disposed in the first case 11. When the cover 12 is disposed on the second surface, the Hall IC 82 is disposed at a position facing the magnet 81. Note that the arrangement of the components of the output shaft angle detector 80 is not limited to the above example, and may be any arrangement. For example, the magnet 81 and the Hall IC 82 may be disposed on either the first case 11 side or the cover 12 side.

As illustrated in FIG. 8, in the first case 11, the connector 84 is disposed on the partition wall 115 that is a region isolated by the partition wall from a region where the first gear 44, the second gear 54, and the output gear part 60 are disposed.

Further, the reinforcing plate 71 has insertion holes 715 and 716 through which a part of a block 90, described later, is inserted, and a cutout 717. The reinforcing plate 71 has a hole through which the screw 73 is inserted, and the screw 73 inserted through the hole is screwed into a screwing hole 95 of the block 90, so that the block 90 is screwed to the reinforcing plate 71. Similarly to the reinforcing plate 71, the reinforcing plate 72 has a hole through which a screw is inserted, and the screw inserted through the hole is screwed into the screwing hole 95 of the block 90, so that the block 90 is screwed to the reinforcing plate 72.

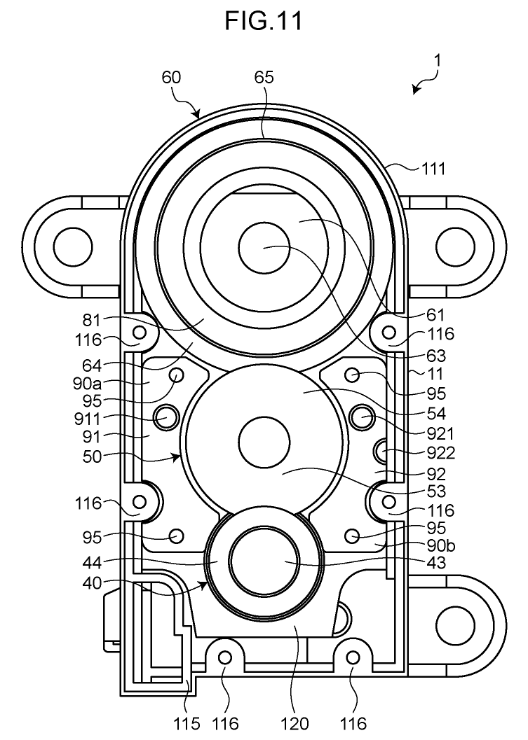

Here, a configuration of the block 90 of the gear housing part 10 will be described with reference to FIGS. 11 to 13. FIG. 11 is a rear view illustrating an example of a configuration within a case of the electric opening/closing device. Specifically, FIG. 11 is a rear view of the electric opening/closing device 1 excluding the cover 12 and the reinforcing plate 71 of the gear housing part 10. In FIG. 11, a pair of blocks 90 disposed at different positions will be described as a block 90a and a block 90b, but the blocks 90a and 90b have the same shape, and when described without making a distinction, they may be described as "block 90".

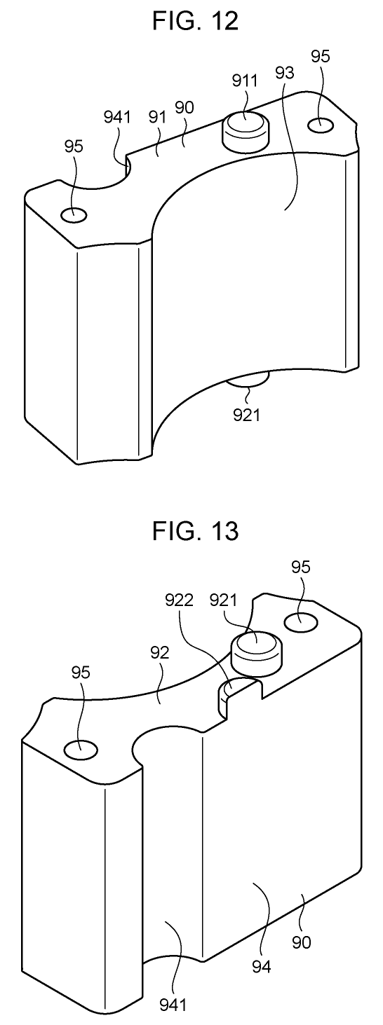

FIGS. 12 and 13 are perspective views illustrating an example of a block of the electric opening/closing device. Specifically, FIG. 12 is a perspective view of the block 90 as viewed from one surface side in the thickness direction. Specifically, FIG. 13 is a perspective view of the block 90 as viewed from the other surface side in the thickness direction.

As illustrated in FIG. 11, the pair of blocks 90 is disposed, between the reinforcing plate 71 and the reinforcing plate 72, at positions sandwiching the second gear 54. The pair of blocks 90 is disposed, between the reinforcing plate 71 and the reinforcing plate 72, in gaps formed on the sides of the second gear 54. For example, the blocks 90 are used to fix the reinforcing plates 71 and 72 to the first case 11.

The pair of blocks 90 of the electric opening/closing device 1 has a common shape. As illustrated in FIGS. 12 and 13, in the block 90, a first surface 91 and a second surface 92, which are a pair of surfaces in the thickness direction, have different uneven shapes.

In addition, the block 90 has, as surfaces along the thickness direction, an inner side surface 93 disposed along the intermediate gear part 50 and an outer side surface 94 disposed along the side peripheral surface 111 when disposed in the electric opening/closing device 1. The inner side surface 93 is formed in a curved surface (concave shape) recessed toward the outer side surface 94 so as to follow the shape of the intermediate gear part 50 when disposed in the electric opening/closing device 1. The outer side surface 94 has a recess 941 that is recessed toward the inner side surface 93 so as to follow the shape of the protrusion 116 of the first case 11 when disposed in the electric opening/closing device 1.

As illustrated in FIG. 12, the block 90 has a columnar first projection 911 on the first surface 91. As illustrated in FIG. 13, the block 90 has a columnar second projection 921 and a semi-columnar third projection 922 on the second surface 92.

As illustrated in FIGS. 8 and 11, the first projection 911 of the block 90a is fitted into the insertion hole 715 of the reinforcing plate 71. The second projection 921 of the block 90a is fitted into an insertion hole of the reinforcing plate 72, and the third projection 922 of the block 90a is fitted into a cutout of the reinforcing plate 72. Similarly, as illustrated in FIGS. 8 and 11, the second projection 921 of the block 90b is fitted into the insertion hole 716 of the reinforcing plate 71, and the third projection 922 of the block 90b is fitted into the cutout 717 of the reinforcing plate 71. The first projection 911 of the block 90b is fitted into the insertion hole of the reinforcing plate 72. As described above, the projections of the blocks 90 are fitted into the insertion holes and the cutout of the reinforcing plate 71 and the reinforcing plate 72, so that the block 90a, the block 90b, the reinforcing plate 71, and the reinforcing plate 72 are positioned.

As described above, when being disposed in the electric opening/closing device 1, the reinforcing plate 72 has the insertion hole and the cutout similar to the insertion hole 716 and the cutout 717 of the reinforcing plate 71 at a location (central portion on the left side in FIG. 11) where the insertion hole 715 of the reinforcing plate 71 is disposed. Further, when being disposed in the electric opening/closing device 1, the reinforcing plate 72 has the insertion hole similar to the insertion hole 715 of the reinforcing plate 71 at a location (central portion on the right side in FIG. 11) where the insertion hole 716 and the cutout 717 of the reinforcing plate 71 are disposed. That is, when being disposed in the electric opening/closing device 1, the reinforcing plate 72 has a line-symmetrical configuration with respect to the reinforcing plate 71 about a line (straight line extending in the up-down direction in FIG. 6) passing through the center between the reinforcing plate 71 and the reinforcing plate 72 at a location where the block 90 is disposed.

The reinforcing plate 72 is positioned by the configuration of the first case 11. For example, a projection is provided on the second surface 120 of the first case 11 toward the inside of the first case 11. The reinforcing plate 72 is positioned by being abutted against the projection on the second surface 120 of the first case 11. With the configuration of the reinforcing plate 71, the reinforcing plate 72, and the block 90 as described above, the block 90 can be appropriately disposed between the reinforcing plate 71 and the reinforcing plate 72, and further, the reinforcing plate 71, the reinforcing plate 72 and the block 90a, and the block 90b can be appropriately disposed with respect to the first case 11.

As described above, in the electric opening/closing device 1, the tooth width TW1 of the third gear 64 is narrower (smaller) than the tooth width TW2 of the second gear 54. For example, the input gear part 40 (first gear 44) supported by the reinforcing plates 71 and 72 has the smallest number of teeth, that is, has a small pitch circle, and therefore, the input gear part 40 is subject to the highest stress, which requires a sufficient tooth width. On the other hand, since the output gear part 60 has a margin in strength as compared with the input gear part 40, the tooth width can be made smaller. Further, as described above, the input gear part 40 and the output gear part 60 are not directly meshed with each other due to the transmission via the intermediate gear part 50 which is an idle gear. Thus, even if the tooth width of the output gear part 60 is reduced, the meshing of the input gear part 40 is not affected.

Therefore, as described above, in the electric opening/closing device 1, a gap (space) is formed in the tooth width direction of the output gear part 60 by reducing the tooth width of only the output gear part 60, and the magnet 81 that is an encoder magnet and the Hall IC 82 are disposed in the gap (space). This increases the outer diameter of the magnet 81 within a range not interfering with the intermediate gear part 50 that is an idle gear. The electric opening/closing device 1 thus enables angle detection on the output side and prevents an increase in size.

In addition, as described above, the assemblability of the electric opening/closing device 1 can be improved by concentrating the Hall IC 82, the substrate part 83, the connector 84, and the like on the cover 12 side. In the electric opening/closing device 1, the connector 84 is disposed at a place separated from other places by the partition wall 115, which is a partition wall (labyrinth), in the first case 11. Further, the first gear 44, the second gear 54, and the third gear 64 are disposed in a region isolated from the outside. As a result, in the electric opening/closing device 1, the gears such as the input gear part 40, the intermediate gear part 50, and the output gear part 60 can be disposed separately from the outside, which reduces the possibility of grease outflow and of foreign matter entering the gears, or the like.

Further, as described above, the electric opening/closing device 1 includes, in the reinforcing plate 71, the first support part 711, the second support part 712, and the third support part 713, which are bearing holes for supporting the other ends 43, 53, and 63 as gear shafts respectively, at the central portion of the reinforcing plate 71, and includes the sensing hole 714 at a position overlapping with the line connecting the centers of the first support part 711, the second support part 712, and the third support part 713.

As described above, the electric opening/closing device 1 includes the sensing hole 714 at the central portion of the reinforcing plate 71, which can maintain the strength balance of the reinforcing plate 71 and reduce the influence on the reinforcement of the reinforcing plate 71 as compared with a case where the end of the reinforcing plate 71 is cut out to enable the angle detection by the output shaft angle detector 80. Therefore, the electric opening/closing device 1 can reduce the influence on the strength of reinforcement by the arrangement of the output shaft angle detector 80, which is the configuration for angle detection. Thereby, in the configuration using the reinforcing plates 71 and 72 in the electric opening/closing device 1, the thickness of the reinforcing plates 71 and 72 can be reduced, allowing the size of the electric opening/closing device 1 to be reduced.

As described above, the electric opening/closing device 1 has a shape in which the blocks 90 for fixing the reinforcing plates 71 and 72 to the first case 11 are divided and disposed on the left and right of the gear part and the blocks 90 are arranged on both sides of the intermediate gear part 50 which is an idle gear. As a result, the electric opening/closing device 1 can improve the strength balance. In addition, the blocks 90 used in the electric opening/closing device 1 have the same shape on the left and right and have a shape that can be used by being flipped over, which allows the use of a single mold, so that an increase in manufacturing costs can be prevented. In addition, in the electric opening/closing device 1, the block 90 is provided at the center in the height direction (for example, the direction in which the input gear part 40, the intermediate gear part 50, and the output gear part 60 are arranged) of the electric opening/closing device 1, which can maintain the strength balance to thereby reduce the thickness of the reinforcing plates 71 and 72.

Here, the operation of the electric opening/closing device 1 having the above configuration will be described. In order to open the toilet lid 5, a controller (not illustrated) supplies a drive signal to rotate the motor 23 in one direction. The planetary gear mechanism 32 rotates according to the rotation of the output rotary shaft 231 due to the rotation of the motor 23, and the input gear part 40 rotates according to the rotation of the planetary gear mechanism 32. The intermediate gear part 50 rotates according to the rotation of the input gear part 40, and the output gear part 60 rotates according to the rotation of the intermediate gear part 50. The rotation of the output gear part 60 is transmitted to a pivot shaft of the toilet lid 5 via the output shaft 62, which allows the toilet lid 5 to open. On the other hand, in order to close the toilet lid 5, the controller rotates the motor 23 in the reverse direction. In such a case, the rotational force of the reverse rotation is transmitted to the pivot shaft of the toilet lid 5, which allows the toilet lid 5 to close.

According to one aspect of the present invention, it is possible to enable angle detection on the output side and to prevent an increase in size.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electric opening/closing device for a toilet device that electrically opens/closes a toilet seat or a toilet lid by driving a motor, the electric opening/closing device for a toilet device comprising:
three or more gears disposed in a case and to which torque of the motor outside the case is transmitted as an input; and
an output shaft that rotates according to rotation of the three or more gears to rotate at least one of the toilet seat and the toilet lid; wherein
out of the three or more gears, with respect to one gear having a smallest number of teeth, another gear having a narrow tooth width is provided on an output shaft side,
the one gear and the other gear are not directly meshed with each other, and
a magnetic sensor configured to detect rotation of the output shaft is disposed in a gap formed in the case due to a difference in tooth width between the three or more gears.

2. The electric opening/closing device for a toilet device according to claim 1, wherein
the case has, on a first surface, a first opening configured to transmit the torque of the motor to the three or more gears and a second opening through which the output shaft extends beyond the case, a second surface facing the first surface is open, and a cover is disposed on the second surface to form an internal space together with the cover, and
a magnet that rotates together with the output shaft is disposed in the internal space.

3. The electric opening/closing device for a toilet device according to claim 2, wherein
the magnetic sensor and a connector connected to the magnetic sensor are attached to the cover, and
when the cover is disposed on the second surface, the magnetic sensor and the connector are disposed in the case.

4. The electric opening/closing device for a toilet device according to claim 3, wherein
when the cover is disposed on the second surface, the magnetic sensor is disposed at a position facing the magnet, and the three or more gears are disposed in a region, of the case, isolated from the outside.

5. The electric opening/closing device for a toilet device according to claim 1, wherein
the output shaft and the other gear are configured separately, and
a torque limiter mechanism is provided between the output shaft and the other gear.

6. The electric opening/closing device for a toilet device according to claim 1, wherein
a diameter of the other gear is largest among the three or more gears.
